(19) United States
(12) Patent Application Publication
(10) Pub. No.: US 2004/0251682 A1
(43) Pub. Date: Dec. 16, 2004

(54) Range taking snap-in connector

(75) Inventor: Roger Pyron, Bartlett, TN (US)

Correspondence Address: HOFFMANN & BARON, LLP, 6900 JERICHO TURNPIKE, SYOSSET, NY, 11791, US

(73) Assignee: Thomas & Betts International, Inc.

(21) Appl. No.: 10/852,976

(22) Filed: May 25, 2004

Related U.S. Application Data
(60) Provisional application No. 60/478,724, filed on Jun. 13, 2003.
(60) Provisional application No. 60/512,582, filed on Oct. 17, 2003.

(51) Int. Cl. F16L 27/00

(52) U.S. Cl. 285/140.1; 285/210; 285/319

(57) ABSTRACT

A connector provides for tooless termination of a conduit. The connector includes a conductor housing having a first end for securement to a box, housing or the like. An opposite second end accommodates the conduit. A conduit securement member is attached to the second end of the housing. The conduit securement member is annular having a plurality of radially inwardly directed deflectable wings. The wings are deflectable upon conduit insertion to accommodate a range of conduit sizes and to establish electrical engagement therewith.

### CROSS-REFERENCE TO RELATED APPLICATIONS

This application claims priority to U.S. Provisional Application No. 60/478,724, filed, Jun. 13, 2003 and U.S. Provisional App No. 60/512,582 filed on Oct. 17, 2003.

### FIELD OF THE INVENTION

This invention relates to a range taking snap-in connector for retaining electrical conduit in the knockout of an electrical enclosure such as a connector box without the use of a locknut or other such threaded fastener. This invention also provides for the accommodation of a plurality of sizes of electrical conduits.

### BACKGROUND OF THE INVENTION

The installation of an electrical wiring system typically requires multiple connections of wires throughout the installed system. The connections must be made in a secure protected manner such as in an electrical connector box, sometimes referred to as a junction box. In making the connections the electrical wires must first be inserted into the connector box and secured therein. Once secured, the wires can be spliced together or connected to an electrical component housed within the box. In a particular type of application, the wires installed into the electrical box are contained within rigid or flexible electrical metal tubing, also commonly known as conduit. With respect to either a flexible or rigid conduit installation however, it is necessary that it be securely anchored to the electrical box to provide; an effective structural connection, and electrical continuity for the purposes of providing a positive ground connection. Typically, this is done using various types of threaded connectors having a lock-nut arrangements or push in connectors. In the case of a threaded connector, a lock nut is screwed onto the threaded end of the conduit once it has been inserted into the electrical box. The locknut acts as a flange to prevent the withdrawal of the conduit from the electrical connector box. Alternately, for non-threaded conduit, a collar having a locknut is threaded into the knockout opening and the conduit is inserted into the collar. Once the conduit is inserted into the electrical connector box, a locknut is tightened to exert pressure on the conduit wall, thus securing the conduit to the connector box.

There are however, problems associated with the use of threaded connectors for securing conduit in electrical boxes. A primary problem is the difficulty in securing the threaded fastener to the conduit once it has been inserted into the connector box because it requires the installer to use two hands. The installer must insert the conduit into the electrical box such that the end protrudes through a knockout opening while attaching the retaining locknut or collar. This can be problematic when space is limited or the electrical connector box is difficult to reach such as for connector boxes in close proximity to other equipment or located above the installer such as for a ceiling fixture.

A further problem in using locknut type connectors is that it requires multiple steps to secure the conduit to the electrical box. The installer must insert the conduit through the knockout, hold the conduit in position to receive the threaded fastener, properly align the locknut on the conduit threads, and finally tighten the locknut. Completion of these steps will usually require the installer to use two hands and/or tools to secure properly the conduit. As previously noted this may be difficult due to limited space or the orientation of the electrical box. Difficulty in reaching the electrical box could cause the installer to insufficiently tighten the locknut, which could result in the locknut and conduit become separated from the electrical box, especially in applications where mechanical vibrations are present. A further difficulty in using prior design connectors is that they are less universal in knockout diameter ranges as they rely on the inner diameter of the knockout opening for to be held secure.

Prior art push in connectors typically utilize tangs or tabs projecting outwardly from the connector as the holding mechanism for the connector. These type of connectors rely on contact with the inside diameter of the knockout hole to provide a secure connection to the electrical box. A drawback of this type of connector is that in order to provide a secure connection, they can only be utilized within a narrow range of knockout hole diameters. If the diameter of a knockout hole is somewhat larger than the standard size, it may not be possible for a prior art push in connector to maintain a secure connection with the electrical box. Thus, for knockout hole size diameters that vary from the standard dimension, the prior art push in connectors are less secure.

Additionally, many prior art connectors are designed to accommodate a single size of electrical conduit. Thus, for the variety of conduits currently available, different sizes of connectors must be employed. This requires an increase in inventory and an associated increase in cost. The need for different sizes of conductors for different sizes of conduits is necessitated by the need to adequately conductively engage the conduit by the connector. A single connector which adequately terminates a large conduit may not achieve effective termination of a smaller size of cable. Electrical conductivity between the connector and the different sizes of conduit cannot always be assured.

### SUMMARY OF THE INVENTION

The present invention provides a conduit connector capable of accommodating one or more conduits of different size.

The connector includes a conduit housing. The housing has first end for insertion into an electrical box. The housing further includes an opposed second end for insertion and receipt of a conduit. A conductive securement member is supported at the second end of the housing. The conduit securement member is a generally annular member having a plurality of radially inwardly directed wings. The wings are deflectable upon conduit insertion to accommodate a range of conduit sizes.

The conduit securement member may be attached to the second end of the housing by securing it thereto. Preferably the conduit securement member may be swaged to the second end of the housing.

The wings of the conduit securement member may be angled inwardly toward the first end of the housing to facilitate insertion of the conduit. The angled wings provide for secure range taking gripping of the conduit.

In a further embodiment, the housing may accommodate a pair of conduits in side-by-side orientation. A pair of conduit securement members may be attached to the second end of the housing. Each conduit securement member of the pair would accommodate a conduit therethrough.

The present invention is further directed to a connector for attaching electrical conduit to an electrical connector box comprising a hollow cylindrical housing defining an internal passageway having a substantially circular first end with a plurality of cantilevered flexible petals, reversely bent back over the exterior of the hollow cylindrical housing, for insertion into an opening in the electrical connector box wall, each petal having a free cantilevered end wherein the diameter of the free cantilevered ends is larger than the opening and a second end having a substantially circular edge and a substantially circular flange that projects radially outwardly from the cylindrical housing having a diameter greater than the opening with, a plurality of resilient cantilevered fingers extending from the flange toward the first end of the cylindrical housing wherein the flange is positioned between the second end and the free cantilevered ends.

The present invention further includes a connector for attaching electrical conduit to an electrical connector box comprising, a hollow cylindrical housing portion defining a passageway having a first end with a radially outwardly directed shoulder and a second end having a circular edge, a hollow cylindrical retainer portion defining a passageway, having a substantially circular first end with a plurality of cantilevered flexible petals, reversely bent back over the exterior of the hollow cylindrical housing, for insertion into an opening in the electrical connector box wall, each petal having a free cantilevered end wherein the diameter of the free cantilevered ends is larger than the opening, and a second end having a flange that projects radially outwardly with, a plurality of resilient cantilevered fingers extending from the flange toward the first end of the retainer, wherein the retainer flange is joined to the housing shoulder to form a cylindrical connector such that the shoulder forms a barrier to limit the insertion of the connector into the electrical box.

### BRIEF DESCRIPTION OF THE DRAWINGS

FIG. 1a is a perspective view of the snap-in connector of the present invention.

FIG. 1b is a perspective view of the snap-in connector of the present invention.

FIG. 2 is a top view of the snap-in connector of the present invention shown affixed to an enclosure wall.

FIG. 3 is a side view of the snap-in connector of the present invention shown affixed to an enclosure wall.

FIG. 4 is a top view of the snap-in connector of the present invention.

FIG. 5 is a detailed cross-sectional view of the snap-in connector according to the present invention shown affixed to an enclosure wall as seen along viewing lines A-A of FIG. 2.

FIG. 6 is a rear perspective showing of a range taking connector of the present invention.

FIG. 7 is a rear plan view of the connector of FIG. 6.

FIG. 8 is a vertical sectional showing of the connector of FIG. 7 taken through the lines A-A thereof.

FIG. 9 shows the connector of FIG. 1, partially in section, terminating a cable conduit.

FIG. 10 is a rear perspective showing of a range taking connector of the present invention capable of accommodating a pair of conduits.

### DETAILED DESCRIPTION OF THE PREFERRED EMBODIMENT

There will be detailed below the preferred embodiments of the present invention with reference to the accompanying drawings. Like members are designated by like reference characters in all figures.

The present invention is directed to a snap-in connector for securely connecting electrical conduit to an electrical connector box that can be used easily and quickly to attach the conduit to the electrical box without the need for a locknut or other threaded fastening device.

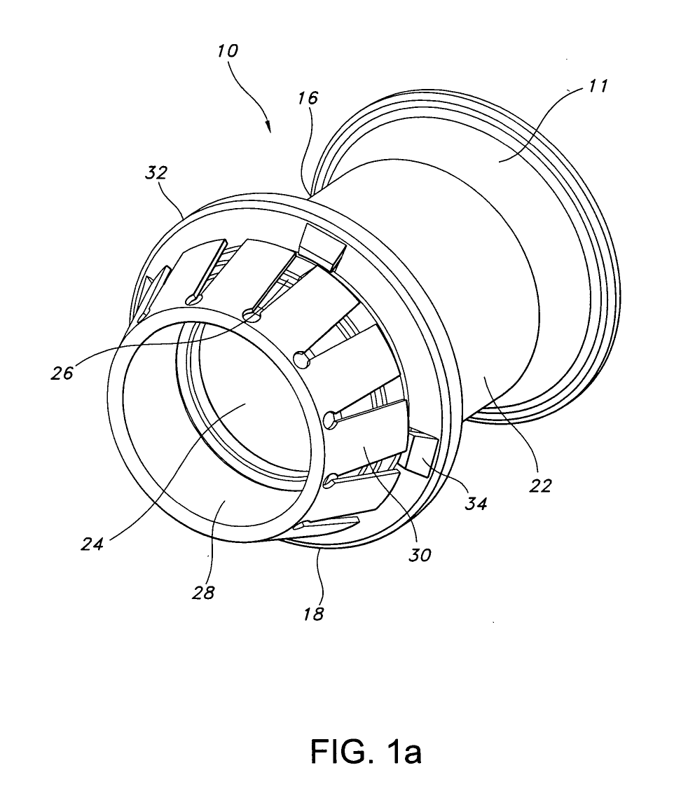

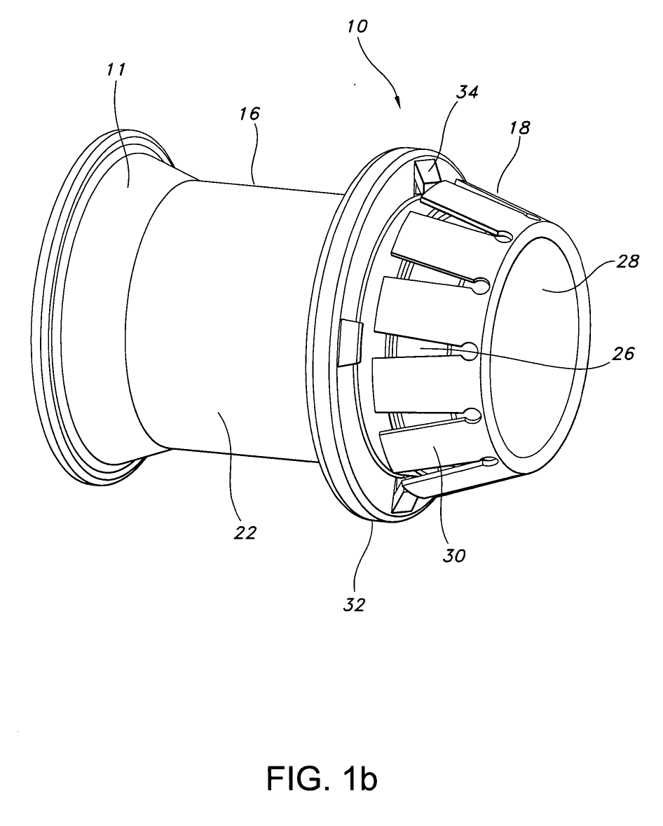

Turning now to the drawings, FIGS. 1a and 1b are perspective views of the snap-in connector of the present invention. The snap-in connector 10 comprises a housing portion 16 and a retainer portion 18. The housing 16 and retainer 18 portions can be two separate parts that are suitably joined together to form connector 10. Both housing 16 and retainer 18 are preferably formed of metal. Housing portions 16 is of generally cylindrical tubular configuration, having at one end a radially outwardly directed shoulder 20, as will be further described hereinafter and a flared conical profile 11 at the other end defining a substantially circular opening. The housing portion body exterior wall 22 is fully continuous around its body circumference and has an interior surface 24 defining a hollow cylindrical aperture for receipt therein of electrical cables or the like.

The connector retainer portion 18 comprises a substantially circular tubular ring 26 that is completely continuous around its body circumference defining a generally cylindrical configuration and having an interior surface 28 forming an opening for receipt therethrough of the electrical cable. At the forward end of the tubular ring 26, a plurality of cantilevered flexible petals 30 are reversely bent back over the exterior of the ring 26, each of the petals 30 extending angularly in flexible cantilevered fashion with respect to the ring 26. Petals 30 are formed on the tubular body of the tubular ring 26 and folded over to create resilient tabs. The petals 30 can be made in varying widths, number, thickness, angles and lengths according to the application. For example, as will be apparent from the description hereinafter, the petals could be made shorter for use with an electrical box having thicker walls, such that in the bent back position, the distance from the free cantilevered end of each petal 30 to shoulder 20 is increased.

Housing portion 16 and retainer portion 18 are joined at shoulder 20, which projects radially outwardly therefrom and substantially perpendicularly to the central axis of the housing 16 and retainer 18 portions. Extending upwardly from the shoulder 20 angularly toward the forward end of the retainer portion 18 are a plurality of resilient cantilevered fingers 34. In the particular arrangement being described, there are four such fingers 34 arranged at approximately 90-degree intervals; however it should be clear to one of ordinary skill in the art that a varying number of fingers can be arranged around the outward extending flange 32.

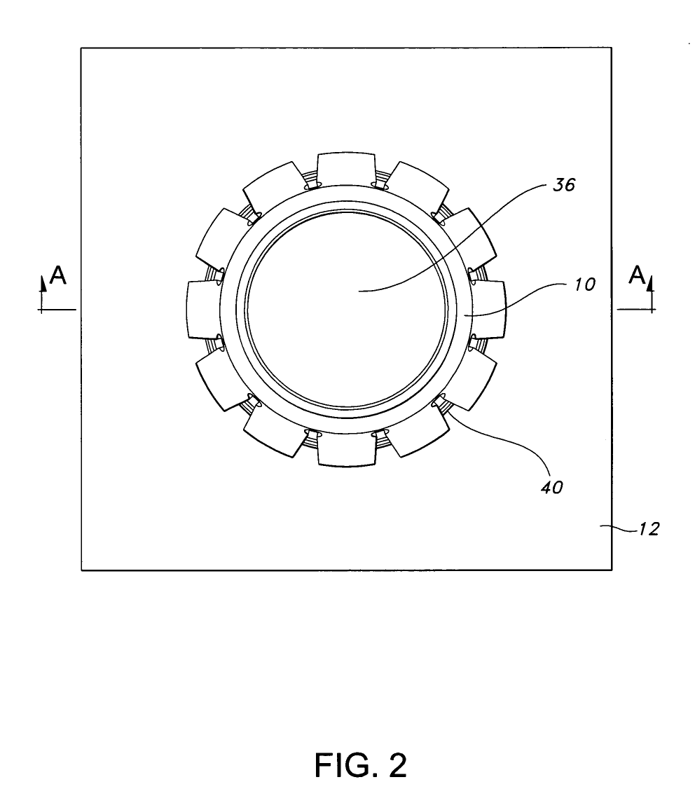

FIG. 2 is a top view of the snap-in connector of the present invention attached to a side wall of an electrical connector box. In this view, the snap-in connector is viewed looking toward the connector from the interior of the connector box. The snap-in connector 10 is shown attached to the wall 12 of an electrical junction box. The snap-in connector 10 is received by an aperture in sidewall 12, portions of the edge 40 of the aperture are visible between petals 30, formed by a standard knockout or the like through the wall 12 of the junction box. The snap-in connector is adapted to receive through aperture 36 suitable electrical conduit. The conduit contains wire for electrical connection to components, such as sockets and switches that are accessible within the electrical junction box. The snap-in connector 10 also being electrically connected to the junction box in order to provide a continuity for a ground circuit.

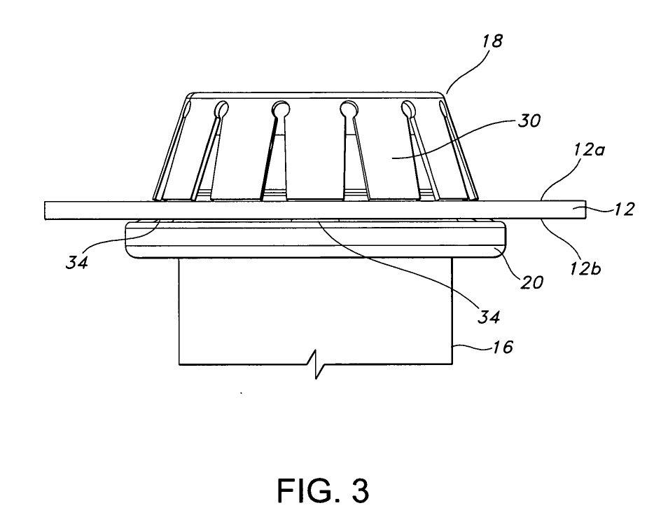

FIG. 3 depicts a partial side view of the snap-in connector of the present invention. In this view, the connector is viewed looking at the connector from the side such as through the open face of a junction box, such that the portions of the connector positioned inside and outside of the box as well as the junction box side wall edge 12 are visible. The edge of side wall 12 is visible and depicted in position between petals 30 and shoulder 20. In this position, the snap in connector is securely held in place by the opposing forces exerted on side wall 12 by fingers 34 and petals 30. As will be further described, fingers 34 bear against the outside surface of junction box wall 12b causing petals 30 to be tightly drawn against inside surface 12a.

FIG. 4 is a top view of the connector 10 according to the present invention. Visible in this view is shoulder 20, which projects radially outwardly from connector 10 and having resilient fingers 34 projecting upwardly therefrom. The walls of connector 10 define aperture 36 which is adapted to receiving suitable electrical conduit. A plurality of petals 30 are reversely bent back over the exterior of the retainer portion 18, wherein each of the petals 30 extend angularly in flexible cantilevered fashion with respect to the retainer portion 18.

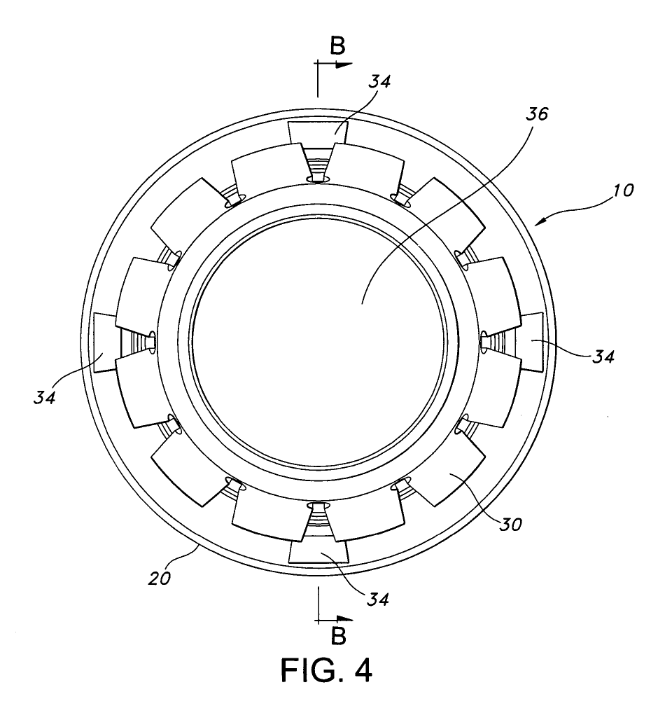

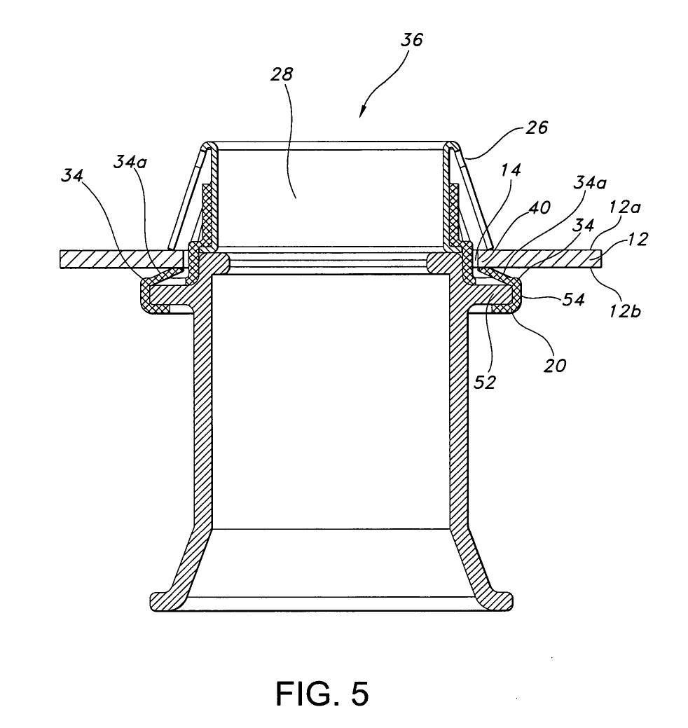

FIG. 5 depicts a longitudinal cross-sectional view A-A from FIG. 2, of the snap-in connector 10 of the present invention. Cross section A-A shows the connector 10 of the present invention securely affixed to a wall 12 of an electrical connector box. Visible is edge 40 of aperture 14, through which retainer portion 18 is inserted into the interior of the connector box (not shown). The cross-sectional view of connector 10 shows the inside view of aperture 36 for receiving electrical conduit so that wires may be passed into the box interior for connection inside the box. Shoulder 20 projects radially outwardly from and substantially perpendicularly to the central axis of the cylindrical ring 26 and is substantially parallel to wall 12 when affixed to an electrical connector box. As can be seen in the cross-sectional view of FIG. 5, shoulder 20 is comprised of a flange 52 extending outwardly from housing portion 16 and a lip 54 of the retainer portion which surrounds the flange circumferentially. The flange 52 of the housing portion 16 can be joined to lip of the retainer portion 18 by rolling the circumferential end of the retainer portion over the circumferential end of the flange 52 in a swaged operation, the housing portions 16 flange 32 being held between the rolled over ends of the retainer portion 18. Extending angularly toward the forward end of the retainer 18 and wall 12 are a plurality of resilient cantilevered fingers 34. In the cross-sectional view of FIG. 5, there are two such fingers 34 visible, which are positioned at approximately 180-degree intervals around shoulder 20. The distance between the distal ends 34a of diametrically opposed fingers 34 is formed to be larger than the diameter of the aperture 14 formed through the junction box wall 12 through which the snap-in connector 10 is received. Thus, the resilient fingers 34 cannot enter the aperture 14, but remain on the outside of the junction box wall 12.

The connector retainer portion 18 comprises a substantially circular tubular ring 26 that is completely continuous around its body circumference defining a generally cylindrical configuration and having an interior surface 28 forming an opening for receipt therethrough of the electrical cable. At the forward end of the retainer ring 26, a plurality of cantilevered flexible petals 30 are reversely bent back over the exterior of the ring 26, each of the petals 30 extending angularly in flexible cantilevered fashion with respect to the ring 26.

As shown in FIG. 5, resilient fingers 34 exert a force on wall exterior 12b such that the distal ends 34a contact exterior surface 12b of wall 12 to urge shoulder 20 of snap-in connector 10 away from side wall 12. Petals 30 are thus urged towards, and brought into contact with wall interior 12a causing a tight mechanical fit.

In use, the connector of the present invention receives a conduit tube into the housing 16 end of the connector. The forward end of the retainer 18 having the folded over resilient petals 30 is inserted through opening 14 of an electrical connector box, causing the petals 30 to radially constrict in diameter until the petals extend fully through the opening, thus releasing the petals 30, allowing them to spring radially outwardly. The distal ends of the petals 30 thereby engage the interior surface 12a of the junction box wall 12. Upon completion of insertion of the retainer 18 into wall opening 14, the distal ends 34a of the flexible fingers 34 resiliently engage the exterior surface 12b of the junction box wall 12. Flexible fingers 34 are biased to urge shoulder 20 of connector 10 away from exterior side wall 12b. The connector 10 by way of the forces exerted on the interior and exterior of wall 12 by resilient petals 30 and the resilient fingers 34 is thereby suitably mechanically and electrically connected to the junction box. The shoulder 20 of connector 10 serves as a mechanical stop during insertion of the connector 10 through aperture 14 of wall 12. As such, no part of the shoulder 20, fingers 34 or housing body 22 extends through aperture 14, the housing portion 16 being fully disposed exteriorly of the wall 12 of the junction box upon attachment of the connectors 10 to the junction box wall 12.

It will be further appreciated that the design of snap-in connector 10 provides for quick, easy, one-step attachment to the junction box. Once a knockout plug is removed the snap-in connector can be attached to a junction box by placing the retainer portion 18 into aperture 14 and the user exerting a force to drive the connector into the connector box. The force on the connector 10 causes petals 30 to constrict radially until the petals extend fully through the opening. In the fully inserted position, shoulder 20 abuts the exterior surface 12b of the junction box, in said position petals 30 spring radially outwardly and, the distal ends 34a of the flexible fingers 34 engage the exterior surface 12b of the junction box wall 12, while distal ends of the petals 30 thereby engage the interior surface 12a of the junction box wall 12.

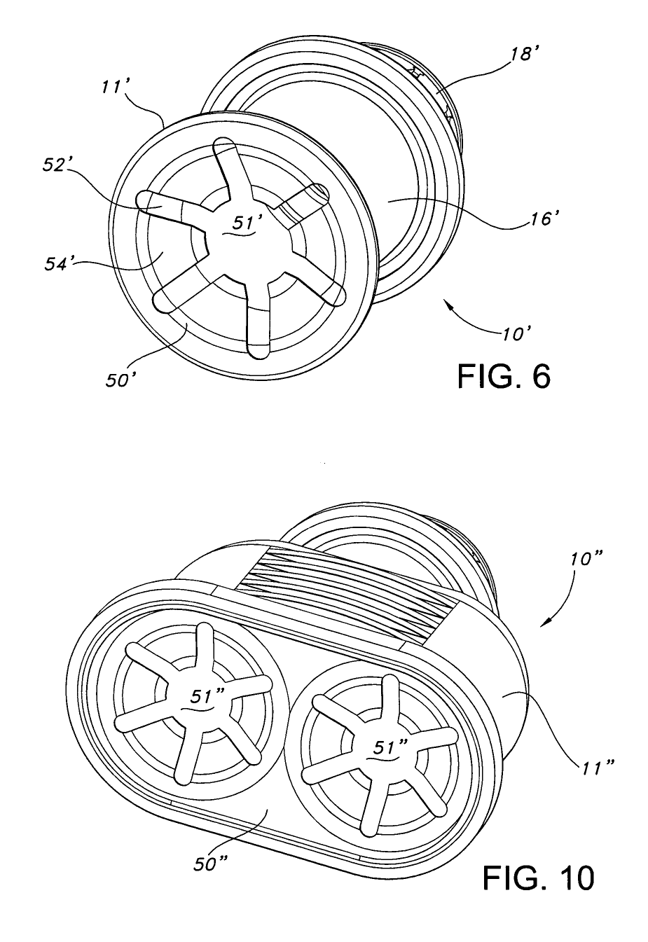

A further embodiment of the present invention is shown in FIGS. 6-8. Connector 10′ is substantially similar to connector 10 of FIG. 1. Connector 10′ includes a housing portion 16′ and a retainer portion 18′ as described above. A flared conical end 11′ is at an end opposite retainer portion 18′. Connector 10′ may also include an insulative throat 13′ adjacent retainer portion 18′.

Attached to flared conical end 11′ is a conduit securement member 50′. Conduit securement member 50′ is an annular member, formed of conductive metal, preferably carbon steel.

Conduit securement member 50′ includes a circumferential portion 52′ which is bent back and around flared end 11′ and is swaged thereto. Other securement techniques such as threading, gluing, welding, crimping and the like may also be employed to attach conduit securement member 50′ to housing 16′. Such attachment provides a secure conductive attachment of the conduite securement member 50′ to housing 16′. Conduit securement member 50′ defines an end opening 51′ for accommodating conduit 70′. Conduit securement member 50′ further includes a plurality of radially inwardly directed wings 54′. Wings 54′ are separated by slots 56 to provide for individual deflection of wings 54′. Each slot 56 is in the shape of a “U” opening toward the center of the annular member.

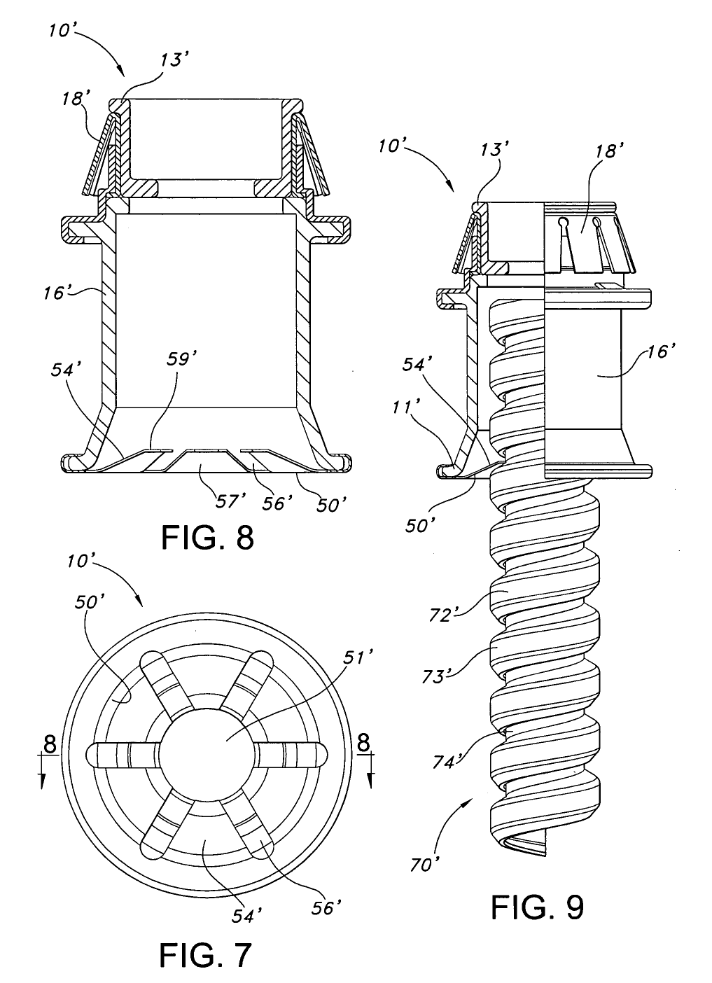

Referring more specifically to FIG. 7, each wing 54′ may be described. Wing 54′ includes a main portion 57′ which is radially inwardly directed and angled inwardly toward the center. Wing 54′ further includes a distal tip 59′ which extends further inwardly but is generally parallel to the open end of housing 16′. The wings 54′ are deflectable upon inward insertion of the conduit thereinto. The U-shaped slots 56′ as well as the size and length of wings 54′, may be designed to alter the insertion force and pullout capabilities of the connector. The design of the wings 54′ and slots 56′ may also compensate for different ranges of conductor sizes.

A further embodiment of the present invention is shown in FIG. 10. Connector 10″ is substantially similar to connector 10′ of FIG. 6. Connector 10″ includes a modified end 11″ which may accommodate a pair of conduits in side-by-side fashion. Conduit securement member 50″ includes a pair of conduit entry openings 51″ for accepting a pair of conduits. Each entry opening 51″ is shaped and configured as described above. The connector 10″ of FIG. 10 allows the conductive accommodation of a pair of conduits in side-by-side orientation.

Having described the connector of the present invention, its use may now be described.

Referring now to FIG. 9, a cable conduit such as a flexible metal conduit 70′ may be terminated. Conduit 70′ has a plurality of helical convolutions 72′ having a wider portion 73′ and a narrow portion 74′. The conduit 70′ is inserted into the end 11′ of housing 16′ through securement member 50′. The wings 54′ deflect inwardly upon such insertion to conform to the shape and diameter of conduit 70′. Once the conduit 70′ is fully inserted, the wings 54′ are placed in a compressive state thereby holding the conduit 70′ in housing 16′. As the wings 54′ are inwardly directed, they facilitate insertion of conduit 70′ into housing 16′. The inwardly directed wings 54′ also prevent withdrawal of the conduit 70′ from the housing 16′.

The deflectablility of wings 54′ allows the wings 54′ to self adjust and accommodate a range of conduit diameters. Furthermore, the shape of conduit securement member 50′ allows the conduit 70′ to be secured without benefit of a tool.

The engagement of tips 59′ with the conduit 70′ assures electrical conductivity therebetween. While such conductive connection is desirable, in situations where conductive engagement is not necessary, the conductor securement member 50′ may be formed of other materials such as plastic.

It will be appreciated that the present invention has been described herein with reference to certain preferred or exemplary embodiments. The preferred or exemplary embodiments described herein may be modified, changed, added to or deviated from without departing from the intent, spirit and scope of the present invention. It is intended that all such additions, modifications, amendments, and/or deviations be included within the scope of the claims appended hereto.

1. A connector for terminating plural sizes of conduits comprising:
an elongate conductive housing, said housing having a first end for insertion into an opening in an electrical box and an opposite second end for insertion and receipt of one of said plurality of sizes of conduit;
a conductive conduit securement member conductively attached to said second end of said housing, said securement member being generally annular having a plurality of radially inwardly directed deflectable wings, said wings being deflectable upon insertion of said plurality of sizes of conduit to establish electrical engagement therewith.

2. A connector of claim 1, wherein said conductive attachment of said conduit securement member includes said conductive securement member being swaged onto said second end of said housing.

3. A connector of claim 2, wherein said wings are angled inwardly toward said first end of said housing for facilitating said insertion of said conduit into said housing.

4. A connector claim 1, wherein said housing accommodates a pair of said conduits in side-by-side orientation.

5. A connector of claim 4, wherein said second end of said housing accommodates a pair of said conduit securement members, each conduit securement member of said pair capable of accommodating an individual one of said plurality of sizes of said conduit.

6. A connector of claim 4 wherein said conduit securement member of said pair are integrally formed.

7. A connector for attaching electrical conduit to an electrical connector box comprising:
a hollow cyclindrical housing defining an internal passageway having;
a substantially circular first end with a plurality of cantilevered flexible petals, reversely bent back over the exterior of said hollow cylindrical housing, for insertion into an opening in said electrical connector box wall, each petal having a free cantilevered end wherein the diameter of said free cantilevered ends is larger than said opening;
a second end having a substantially circular edge;
a substantially circular flange that projects radially outwardly from said cylindrical housing having a diameter greater than said opening with, a plurality of resilient cantilevered fingers extending from said flange toward said first end of said cylindrical housing wherein said flange is positioned between said second end and said free cantilevered ends.

8. The connector of claim 7 wherein said flange has a larger diameter than the diameter of said free cantilevered ends of said petals.

9. The connector of claim 7 wherein said cantilevered flexible petals, are reversely bent at an angle between 140 and 160 degrees to the central axis of said hollow cylindrical housing.

10. The connector of claim 7 wherein the distance between said flange and said free cantilevered ends is equal to or greater than said electrical connector box wall thickness.

11. The connector of claim 7 having four said resilient cantilevered fingers arranged at approximately 90 degree intervals around said flange.

12. The connector of claim 7 having three said resilient cantilevered fingers arranged at approximately 120 degree intervals around said flange.

13. The connector of claim 7 having five said resilient cantilevered fingers arranged at approximately 72 degree intervals around said flange.

14. The connector of claim 7 having six said resilient cantilevered fingers arranged at approximately 60 degree intervals around said flange.

15. The connector of claim 7 having a plurality of inwardly biased resiliently tabs on said cylindrical body adjacent said substantially circular edge.

16. A connector for attaching electrical conduit to an electrical connector box comprising:
a hollow cylindrical housing portion defining a passageway having a first end with a radially outwardly directed shoulder and a second end having a circular edge;
a hollow cylindrical retainer portion defining a passageway, having a substantially circular first end with a plurality of cantilevered flexible petals, reversely bent back over the exterior of said hollow cylindrical housing, for insertion into an opening in said electrical connector box wall, each petal having a free cantilevered end wherein the diameter of said free cantilevered ends is larger than said opening, and a second end having a flange that projects radially outwardly with, a plurality of resilient cantilevered fingers extending from said flange toward said first end of said retainer;
wherein said retainer flange is joined to said housing shoulder to form a cylindrical connector such that said shoulder forms a barrier to limit the insertion of said connector into said electrical box.

17. The connector of claim 16 wherein said flange has a larger diameter than the diameter of said free cantilevered ends of said petals.

18. The connector of claim 16 wherein said cantilevered flexible petals, are reversely bent at an angle between 140 and 160 degrees to the central axis of said hollow cylindrical housing.

19. The connector of claim 16 wherein the distance between said flange and said free cantilevered ends is equal to or greater than said electrical connector box wall thickness.

20. The connector of claim 16 having four said resilient cantilevered fingers arranged at approximately 90 degree intervals around said flange.

21. The connector of claim 16 having three said resilient cantilevered fingers arranged at approximately 120 degree intervals around said flange.

22. The connector of claim 16 having five said resilient cantilevered fingers arranged at approximately 72 degree intervals The connector of claim 16 having five said resilient cantilevered fingers arranged at approximately 72 degree intervals around said flange.

23. The connector of claim 16 having six said resilient cantilevered fingers arranged at approximately 60 degree intervals around said flange.

24. The connector of claim 16 having a pluarality of inwardly biased resiliently tabs on said housing portion adjacent said circular edge.
